(19) United States
(12) Patent Application Publication
(10) Pub. No.: US 2023/0294690 A1
(43) Pub. Date: Sep. 21, 2023

(54) METHOD FOR AUTOMATED MANAGEMENT OF THE LONGITUDINAL SPEED OF A VEHICLE

(71) Applicant: RENAULT S.A.S, Boulogne Billancourt (FR)

(72) Inventors: Pedro KVIESKA, Versailles (FR); Guillermo PITA-GIL, Versailles (FR)

(73) Assignee: RENAULT S.A.S, Boulogne Billancourt (FR)

(21) Appl. No.: 18/041,364

(22) PCT Filed: Jul. 27, 2021
(86) PCT No.: PCT/EP2021/070929

§ 371 Date: Feb. 10, 2023

(30) Foreign Application Priority Data
Aug. 12, 2020 (FR) FR2008464

(51) Int. Cl. B60W 30/14; B60W 30/16; B60W 40/105; G06V 20/58

(52) U.S. Cl. CPC B60W 30/143; B60W 30/16; B60W 40/105; G06V 20/584; B60W 2554/4045; B60W 2554/802; B60W 2554/804

(57) ABSTRACT

A method for automated management of the longitudinal speed of a first vehicle travelling on a first lane includes: detecting an intention of a second vehicle travelling on a second lane adjacent to the first lane to perform an insertion maneuver on the first lane; estimating a corrected longitudinal distance, the corrected longitudinal distance corresponding to the longitudinal distance that will separate the first vehicle from the second vehicle at the end of the insertion maneuver, the corrected longitudinal distance being calculated as a function of a measured longitudinal distance between the first vehicle and the second vehicle, and as a function of a relative longitudinal speed measured between the second vehicle and the first vehicle; and calculating a longitudinal speed setpoint of the first vehicle as a function of the corrected longitudinal distance.

The invention relates to a method for the automated management of the longitudinal speed of a vehicle. The invention also relates to a device for the automated management of the longitudinal speed of a vehicle. The invention also relates to a motor vehicle comprising such an automated management device.

Driving assistance technologies are becoming increasingly widespread and are no longer limited to high-specification 15 vehicles.

These technologies make it possible to simplify the driving of motor vehicles and/or to make the behavior of the drivers of the vehicles more reliable.

Some automated speed management systems are commonly installed in modern vehicles, these generally operating on the basis of regulating distance between the vehicle fitted therewith, also called ego vehicle, and the vehicle in front thereof in its traffic lane, called target.

Some automated speed management systems also take into consideration targets performing a cut-in maneuver before the cut-in thereof into the lane of the ego vehicle takes place. However, anticipating the speed regulation with respect to a target entering into the lane of the ego vehicle may generate discomfort when driving.

The aim of the invention is to provide a system and a method for the automated management of the longitudinal speed of a vehicle that rectifies the abovementioned drawbacks.

A first subject of the invention is a method for managing longitudinal speed that produces a comfortable and reassuring regulation for the passengers in the vehicle.

To this end, the invention relates to a method for the automated management of the longitudinal speed of a first vehicle traveling in a first lane. The method comprises the following steps:
a first step of detecting an intention of a second vehicle traveling in a second lane adjacent to the first lane to perform a cut-in maneuver into the first lane,
a second step of estimating a corrected longitudinal distance, the corrected longitudinal distance corresponding to the longitudinal distance that will separate the first vehicle from the second vehicle at the end of the cut-in maneuver, the corrected longitudinal distance being computed based on a longitudinal distance measured between the first vehicle and the second vehicle, and based on a relative longitudinal speed measured between the second vehicle and the first vehicle,
a third step of computing a longitudinal speed setpoint for the first vehicle based on the corrected longitudinal distance.

The first detection step may comprise a sub-step of computing a time to line crossing, and then a sub-step of comparing the time to line crossing with a predefined threshold.

The corrected longitudinal distance computed in the second step may depend on the measured longitudinal distance, on the measured relative longitudinal speed and on the time to crossing.

The corrected longitudinal distance computed in the second step may be equal to the sum of the measured longitudinal distance and the product of the measured relative longitudinal speed and the time to crossing.

The first detection step may comprise a sub-step of detecting visual indicators on the second vehicle signaling a cut-in maneuver, in particular detection of the use of flashing lights.

The method may comprise a step of comparing the speed of the first vehicle and the speed of the second vehicle, the longitudinal speed setpoint computed in the third step being a strong deceleration setpoint if the speed of the second vehicle is strictly less than the speed of the first vehicle, and the longitudinal speed setpoint computed in the third step being a weak deceleration setpoint if the speed of the second vehicle is strictly greater than the speed of the first vehicle.

The method may comprise:
a step of computing a first reference longitudinal speed based on the corrected longitudinal distance,
a step of detecting at least one third vehicle in traffic around the first vehicle,
a step of computing at least one second reference longitudinal speed based on the speed of the at least one third vehicle.
   The longitudinal speed setpoint computed in the third step may be equal to the minimum of the first reference longitudinal speed and the at least one second reference longitudinal speed.

The second vehicle and the at least one third vehicle may be situated ahead of the first vehicle.

The invention also relates to a device for the automated management of the longitudinal speed of a vehicle, the device comprising hardware and/or software elements implementing a method as defined above.

The invention also relates to a motor vehicle comprising a device for the automated management of the longitudinal speed of a vehicle as defined above.

The invention also relates to a computer program product comprising program code instructions recorded on a computer-readable medium for implementing the steps of the method defined above when said program runs on a computer and/or to a computer program product able to be downloaded from a communication network and/or recorded on a computer-readable and/or computer-executable data medium, characterized in that it comprises instructions that, when the program is executed by the computer, prompt said computer to implement the method defined above.

The invention also relates to a computer-readable data recording medium on which is recorded a computer program comprising program code instructions for implementing the method defined above and/or to a computer-readable recording medium comprising instructions that, when they are executed by a computer, prompt said computer to implement the method defined above.

The invention also relates to a signal of a data medium carrying the computer program product defined above.

The appended drawing shows, by way of example, one embodiment of a device for the automated management of longitudinal speed according to the invention and one mode of execution of a method for the automated management of longitudinal speed according to the invention.

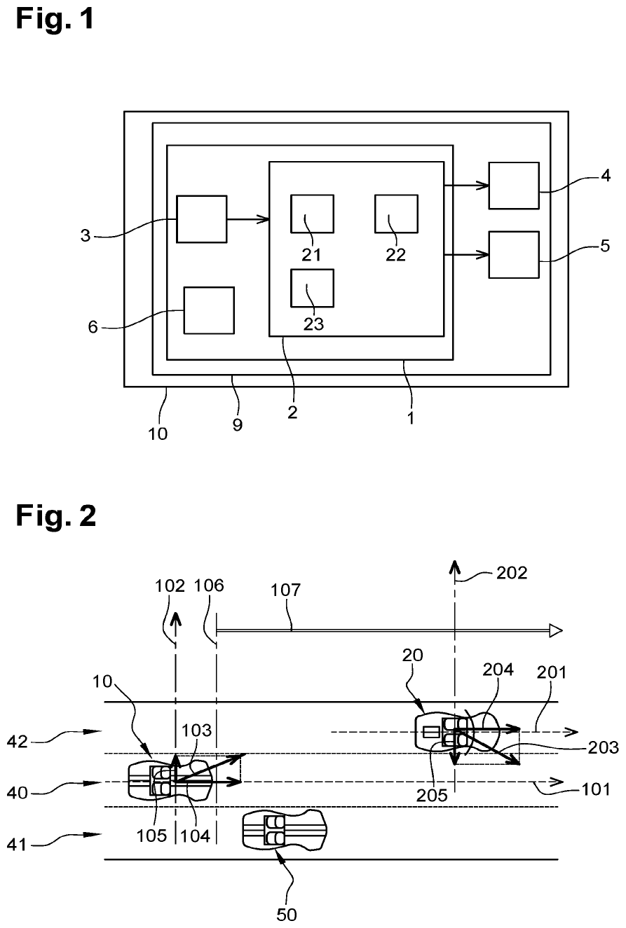

FIG. 1 schematically shows one embodiment of a vehicle equipped with a means for implementing a method for the automated management of the longitudinal speed of a motor vehicle.

FIG. 2 schematically shows a first traffic configuration taken into consideration by the method for managing the longitudinal speed of a motor vehicle.

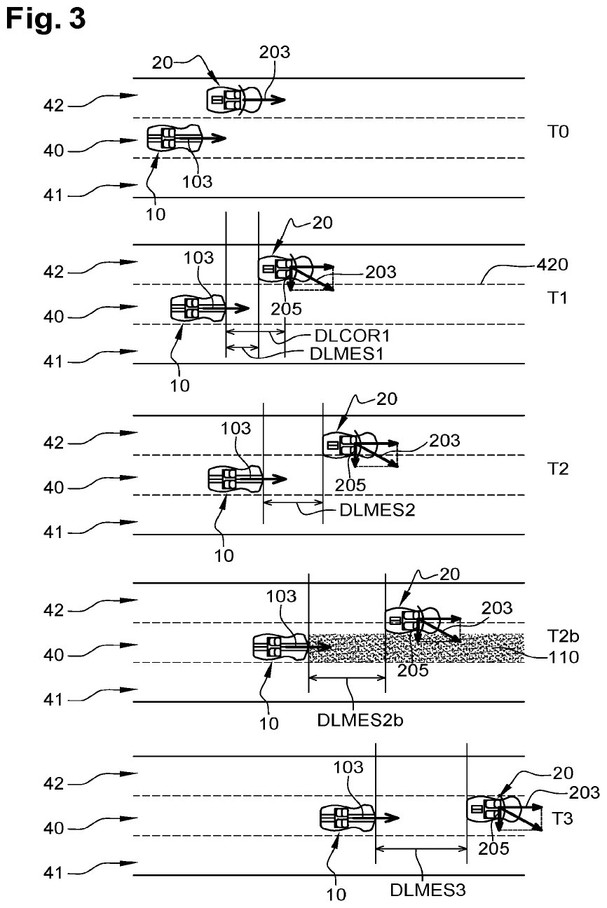

FIG. 3 illustrates how a cut-in maneuver takes place over time.

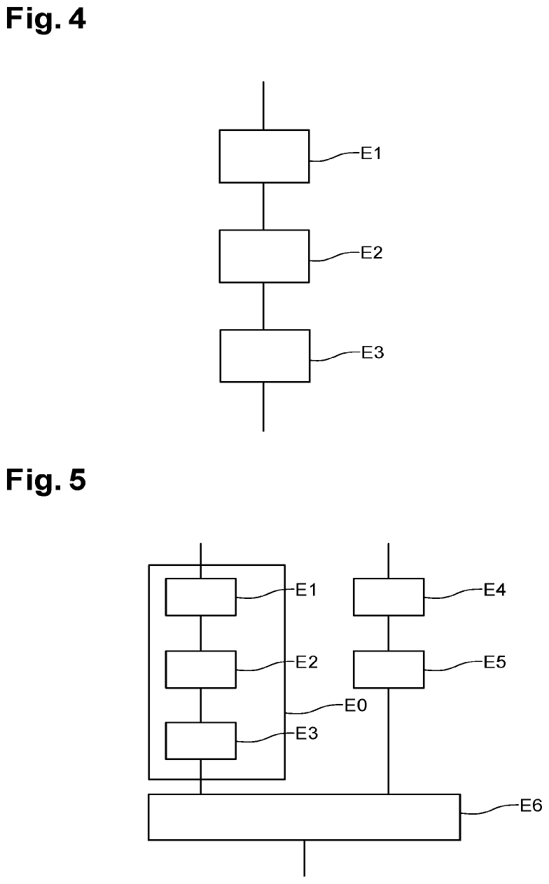

FIG. 4 is a flowchart of a first mode of execution of a method for the automated management of the longitudinal speed of a motor vehicle.

FIG. 5 is a flowchart of a second mode of execution of a method for the automated management of the longitudinal speed of a motor vehicle.

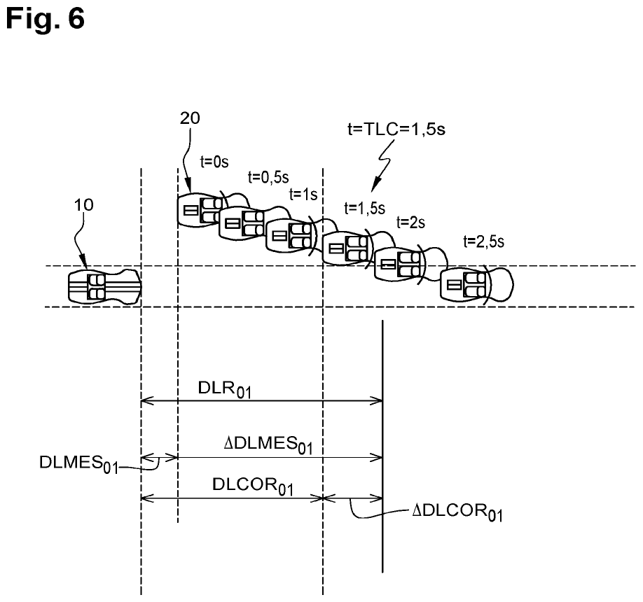

FIG. 6 illustrates the implementation of the method in a first traffic configuration.

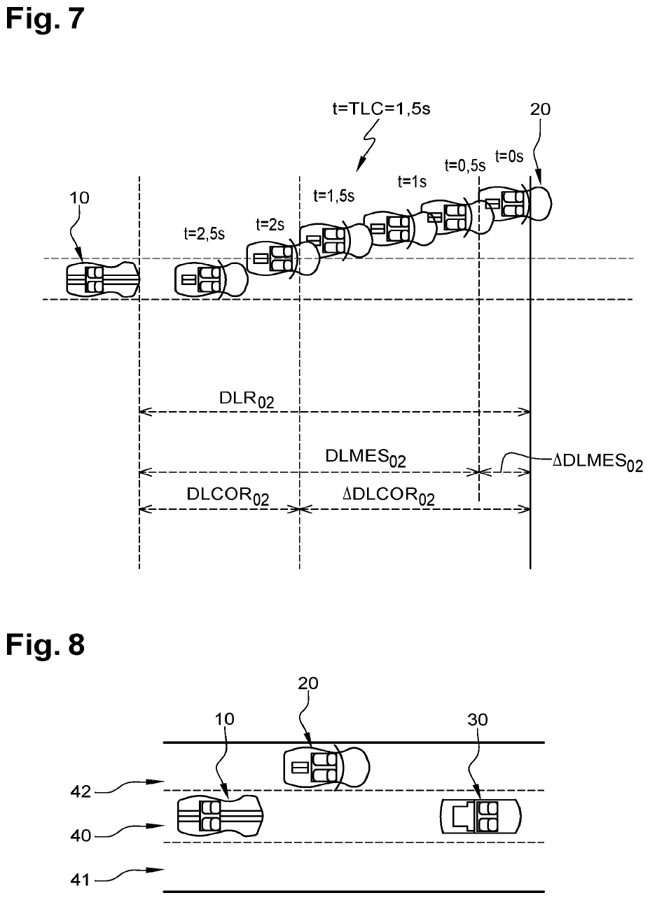

FIG. 7 illustrates the implementation of the method in a second traffic configuration.

FIG. 8 schematically shows a second traffic configuration taken into consideration by the method for managing the longitudinal speed of a motor vehicle.

One embodiment of a vehicle equipped with a means for implementing a method for the automated management of longitudinal speed is described below with reference to FIG. 1.

The motor vehicle 10 is a motor vehicle of any type, in particular a leisure vehicle or a utility vehicle. In this description of one embodiment, the vehicle comprising the means for implementing the invention is called “ego” vehicle. This name makes it possible only to distinguish it from other nearby vehicles and does not confer any technical limitation per se on the motor vehicle 10.

The first motor vehicle 10 or ego vehicle 10 comprises a system 1 for the automated management of the longitudinal speed of a motor vehicle.

The system 1 for the automated management of the longitudinal speed of a motor vehicle may form part of a more global driving assistance system 9.

The system 1 for the automated management of the longitudinal speed of a motor vehicle comprises primarily the following elements:
a detection means 3 for detecting vehicles traveling in the lane of the motor vehicle 10, called main lane, and in the traffic lanes, called adjacent lanes, located on either side of the main lane,
a microprocessor 2,
a memory 6.

The system 1 for the automated management of the longitudinal speed of a motor vehicle, and particularly the microprocessor 2, comprises primarily the following modules:
a module 21 for detecting an intention of a second vehicle traveling in a second lane adjacent to the first lane to perform a cut-in maneuver into the first lane, this module being able to interact with the detection means 3,
a module 22 for estimating a corrected longitudinal distance that will separate the ego vehicle 10 from the second vehicle at the end of the cut-in maneuver, this module being able to interact with the detection means 3,
a module 23 for computing a longitudinal speed setpoint for the ego vehicle based on said corrected longitudinal distance, this module being able to interact with the detection means.

The motor vehicle 10, in particular the system 1 for the automated management of the longitudinal speed of a motor vehicle, preferably comprises all of the hardware and/or software elements configured so as to implement the method defined in the subject of the invention or the method described further below.

The detection means 3 may comprise for example a radar, and/or a lidar, and/or a camera and/or any other type of sensor suitable for detecting targets in the environment of the ego vehicle.

The detection means 3 may provide measurements to the microprocessor 2, including:
the longitudinal distance between the ego vehicle and the surrounding vehicles,
the longitudinal and lateral speeds of the surrounding vehicles,
the longitudinal and lateral acceleration of the surrounding vehicles, and
the relative longitudinal speed of the surrounding vehicles with respect to the ego vehicle.

As a variant, some of these measurements could be computed by the microprocessor on the basis of measurements supplied by the detection means 3. These measurements may be repeated indefinitely at a given frequency.

The microprocessor 2 may furthermore also receive information relating to the longitudinal speed of the ego vehicle, for example by way of speed sensors of the ego vehicle connected to the system 1. The microprocessor 2 may also receive information relating to the lateral distance between the ego vehicle and surrounding vehicles and/or information for positioning the ego vehicle in a reference frame, in particular for positioning the ego vehicle with respect to demarcation lines.

The module 23 for computing a longitudinal speed setpoint is able to transmit control orders to an engine 4 or to a braking system 5 of the vehicle so as to control the longitudinal speed of the ego vehicle.

The system 1 for the automated management of the longitudinal speed of a motor vehicle comprises a memory 6. The memory 6 constitutes a recording medium able to be read by a computer or by the processor, comprising instructions that, when they are executed by the computer or the processor, prompt same to implement a method for the automated management of longitudinal speed according to one embodiment of the invention.

With reference to FIG. 2, it is assumed that the ego vehicle 10 is traveling on a roadway containing at least two traffic lanes in the same direction. In the example illustrated in FIG. 2, the ego vehicle 10 is positioned in the central lane 40 of a three-lane road. Two traffic lanes 41, 42 are therefore adjacent to the central lane 40 and are located on either side thereof.

With reference to FIG. 2, a definition is given of the terminology used in the rest of the document:
The axis called the longitudinal axis 101 of the ego vehicle is defined as being an axis of symmetry of the ego vehicle parallel to the axis along which the vehicle moves in a straight line, oriented ahead of the vehicle.
The axis called the lateral axis 102 of the ego vehicle perpendicularly intersects the longitudinal axis 101 at a point situated at the center of gravity of the ego vehicle, and it is oriented to the left of the ego vehicle, the left and the right being defined according to the viewpoint of the driver.
The speed vector 103 of the ego vehicle in a projection onto the longitudinal axis 101 defines the longitudinal component 104 of the speed vector, called longitudinal speed.
The speed vector 103 of the ego vehicle in a projection onto the lateral axis 102 defines the lateral component 105 of the speed vector, called lateral speed.
Likewise, a distance between two vehicles may be projected onto the longitudinal and lateral axes, thus defining a longitudinal distance and a lateral distance.
By convention, a vehicle will be considered to be situated ahead of the ego vehicle if it is located at least partially (for example to at least 50%) in the hemispace delimited by an axis 106 parallel to the lateral axis 102 and passing through the front end of the front bumpers of the ego vehicle and oriented in the direction of the axis 101. This hemispace therefore corresponds to an area 107 called traffic area situated ahead of the ego vehicle.
The traffic lane of the ego vehicle 40 is called main lane.
The traffic lanes 41 and 42 adjacent to the main lane and situated on either side of this lane are called adjacent lanes.

The same terminology is applied to define the position parameters and speed parameters of a second vehicle 20, shown in FIG. 2. This second vehicle 20 is characterized by the fact that it is situated in the traffic around the ego vehicle, more particularly that it is traveling in an adjacent lane 41, 42 and that its trajectory parameters (including position and speed) are taken into consideration when computing the setpoint longitudinal speed of the ego vehicle. In the rest of the document, this second vehicle 20 may also be referred to using the term target vehicle 20.

A target vehicle may be a motor vehicle of any type, in particular a leisure vehicle or a utility vehicle or even a motorcycle.

The position parameters and speed parameters of the target vehicle 20 are defined as follows, with reference to FIG. 2:
The axis called the longitudinal axis 201 of the target vehicle 20 is defined as being its axis of longitudinal symmetry, oriented ahead of the vehicle.
The axis called the lateral axis 202 of the target vehicle 20 perpendicularly intersects the longitudinal axis 201 at a point situated at the center of gravity of the target vehicle, and it is oriented to the left of the target vehicle.
The speed vector 203 of the target vehicle 20 in a projection onto the longitudinal axis 201 defines the longitudinal component 204 of the speed vector, called longitudinal speed.
The speed vector 203 of the target vehicle 20 in a projection onto the lateral axis 202 defines the lateral component 205 of the speed vector, called lateral speed.

In the rest of the document, “cut-in maneuver” denotes a driving sequence allowing a target vehicle 20, 50 traveling in an adjacent lane 41, 42 to cut in ahead of the ego vehicle, into the traffic in the main driving lane 40.

In the rest of the document, “traffic corridor of the ego vehicle” denotes an area of the traffic lane of the ego vehicle that is delimited laterally by two notional lines parallel to the longitudinal axis of the ego vehicle, these two lines being equidistant from the longitudinal axis of the ego vehicle. In one embodiment, the traffic corridor may be defined as the longitudinal projection of the ego vehicle onto its traffic lane. In this embodiment, the width of the traffic corridor therefore corresponds to the width of the ego vehicle. In one alternative embodiment, the width of the traffic corridor of the ego vehicle could be different from the width of the ego vehicle, preferably greater than said width of the ego vehicle. In this embodiment, the width of the traffic corridor may for example define a margin of 30 cm on either side of the ego vehicle.

FIG. 3 shows the key times of a cut-in maneuver for a target vehicle 20 into the lane of the ego vehicle 10:
At the time T0, the target vehicle 20 overtakes the ego vehicle 10. Its speed is then purely longitudinal. Its intention to perform a cut-in maneuver is therefore not able to be detected through its driving parameters: its lateral speed and its lateral acceleration are very small and its trajectory remains centered on its traffic lane 42. At this stage, the target vehicle 20 may signal its intention to perform a cut-in maneuver, for example using visual indicators (flashing lights).
At the time T1, the target vehicle 20 has a nonzero lateral speed 205 and possibly a nonzero lateral acceleration. It has therefore moved toward the demarcation line 420 situated between the lane of the ego vehicle and that of the target vehicle. At this stage, the driving parameters of the target vehicle 20 allow the ego vehicle to detect an intention of the target vehicle 20 to perform a cut-in maneuver into the lane of the ego vehicle.
At the time T2, the target vehicle 20 crosses the demarcation line that separates its lane from that of the ego vehicle.
At the time T2b, the target vehicle 20 penetrates into a traffic corridor 110 centered on the longitudinal axis of the ego vehicle 10.
At the time T3, the target vehicle 20 is situated entirely in the traffic lane of the ego vehicle.

The criterion establishing line crossing by a vehicle may be defined as being the crossing of this line by at least one point of the following parts of the vehicle:
the lateral edge of the chassis of the vehicle, this lateral edge being closest to the ego vehicle, or
the lateral edge of at least one of the wheels of this vehicle, or
the center of gravity of this vehicle.

As an alternative, the criterion establishing line crossing by a vehicle may be defined as being the crossing of this line by the whole vehicle.

Preferably, the crossing criterion is defined as being the crossing of this line by at least one point of a lateral edge of the chassis of this vehicle.

In the rest of the document, the expression “end of the cut-in maneuver” may denote the time T3 starting from which the target vehicle 20 is situated entirely in the traffic lane of the ego vehicle. Preferably, the end of the cut-in maneuver may be seen as the time T2b at which the target vehicle 20 penetrates into a traffic corridor centered on the longitudinal axis of the ego vehicle. According to another variant embodiment, the end of the cut-in maneuver could also be seen as the time T2 of crossing the demarcation line.

A first mode of execution of a method for the automated management of longitudinal speed is described below with reference to FIG. 3. The management method may also be seen as being a method for operating a management system or as a method for operating a motor vehicle equipped with a management system. This first mode of execution of the method comprises three steps E1, E2 and E3, which will be described below.

In a first step E1, an intention of a target vehicle 20, traveling in an adjacent lane 41, to perform a cut-in maneuver into the main lane 40 is detected.

With reference to FIG. 3 described above, an intention to perform a cut-in maneuver may be detected between the time TO and the time T1. Indeed, as illustrated at the time TO, detecting an intention to perform a cut-in maneuver may involve detecting flashing lights even before the vehicle begins maneuvering, that is to say before the target vehicle 20 begins moving toward the demarcation line 420 situated between its traffic lane 42 and that of the ego vehicle 40.

In addition or as an alternative, an intention to perform a cut-in maneuver may be detected at a time T1 at which the target vehicle has initiated a lateral movement toward the demarcation line 420. In this case, detecting an intention to perform a cut-in maneuver may involve trajectory parameters of the target vehicle 20. In the case of vehicles traveling in rectilinear lanes, the start of the insertion maneuver is manifested by an increase in the lateral speed 205 and possibly in the lateral acceleration of the target vehicle 20. The method may therefore utilize the data from the detection means 3 to compare the lateral speed and/or the lateral acceleration of the target vehicle 20 with minimum thresholds.

In addition or as an alternative, the method uses trajectory data of the target vehicle 20 to estimate a time to line crossing (TLC in acronym form), corresponding to the time at the end of which the target vehicle 20 will cross a limit situated between the ego vehicle and the target vehicle.

In one preferred embodiment, the TLC relates to the crossing of a lateral limit of a traffic corridor 110 centered on the longitudinal axis of the ego vehicle 10. Calibrating the width of this corridor makes it possible to refine the estimate of the time at which the trajectory of the target vehicle 20 will effectively intersect that of the ego vehicle.

Preferably, the width of the corridor 110 is therefore greater than the width of the ego vehicle and less than the width of a highway traffic lane.

On the basis of one or the other of the options for computing a TLC time, the method detects an intention to perform a cut-in maneuver by comparing the TLC time with a maximum threshold, for example 1.5 seconds.

In one variant implementation, the method combines the conditions presented above in order to detect an intention to perform a cut-in maneuver.

According to another variant, an intention to perform a cut-in maneuver could be detected by way of an inter-vehicle communication device and/or by way of a device for communication with a remote server and/or by way of a geolocation device.

At a given time, the method detects an intention to perform a cut-in maneuver and moves to a second step E2 of estimating a corrected longitudinal distance DLCOR.

The corrected longitudinal distance DLCOR corresponds to an estimate of the longitudinal distance that will separate the ego vehicle 10 from the target vehicle 20 at the end of the cut-in maneuver.

For example, with reference to FIG. 3, the time of detection of an intention to perform a cut-in maneuver is T1. At the time T1, a corrected longitudinal distance DLCOR1 is estimated, the significance of which depends on the criterion chosen to compute the TLC:
if the TLC is computed using a criterion regarding crossing of the demarcation line between the lanes 40 and 42, then TLC=T2 and DLCOR1 will be an estimate of the distance DLMES2 that will separate the ego vehicle 10 from the target vehicle 20 at the time T2:
if the TLC is computed using a criterion regarding the target vehicle 20 penetrating into a traffic corridor centered on the longitudinal axis of the ego vehicle, then TLC=T2b and DLCOR1 will be an estimate of the distance DLMES2b that will separate the ego vehicle 10 from the target vehicle 20 at the time T2b,
if the TLC is computed as being the time at which the target vehicle 20 is situated entirely in the traffic lane of the ego vehicle, then TLC=T3 and DLCOR1 will be an estimate of the distance DLMES3 that will separate the ego vehicle 10 from the target vehicle 20 at the time T3.

At a time t, the corrected longitudinal distance may be estimated from the driving parameters of the ego vehicle 10 and of the target vehicle 20, these parameters being measured at the time t.

The method thus computes a corrected longitudinal distance DLCOR(t) using the formula

DLCOR(t)=maximum(0,DLMES(t)+VLR(t)×TLC(t))

where:
DLMES(t) is the longitudinal distance measured at the time t between the ego vehicle 10 and the target vehicle 20,
VLR(t) is the relative longitudinal speed measured at the time t between the ego vehicle 10 and the target vehicle 20, and
TLC(t) is an estimate at the time t of the time to line crossing.

The relative longitudinal speed VLR(t) measured between the ego vehicle 10 and the target vehicle 20 may be positive or negative. Thus, to avoid obtaining a negative value when computing the corrected longitudinal distance DLCOR, the function “maximum ( )” is used to bound the result of this computation to the minimum value of 0.

A corrected longitudinal distance DLCOR(t) is thus computed in real time in order to be transmitted to a third step E3 of computing a longitudinal speed setpoint VLC, applicable at the time t.

At each time t, a corrected longitudinal distance DLCOR(t) is computed depending on the relative longitudinal speed VLR(t). The corrected longitudinal distance DLCOR(t) thus computed may vary over time if the relative longitudinal speed between the first and the second vehicle varies. This thus gives an estimate of the corrected longitudinal distance DLCOR(t) that will be all the more precise the more the relative longitudinal speed VLR(t) remains substantially constant beyond the time t. According to one variant embodiment of the invention, the corrected longitudinal distance DLCOR(t) could also be computed based on an acceleration of the first vehicle and/or of the second vehicle, measured or computed at the time t. Such accelerations could be integrated over a period of time equal to the time TLC(t). The computation of the corrected longitudinal distance DLCOR(t) could thus be more complex but also more precise.

In one embodiment of step E3, the longitudinal speed setpoint VLC may be computed so as to establish and maintain a reference longitudinal distance DLR between the ego vehicle 10 and the target 20. In other words, based on the corrected longitudinal distance DLCOR, computed in step E2, the method computes the longitudinal speed setpoint VLC that the ego vehicle 10 should apply in order for the longitudinal distance measured between the ego vehicle 10 and the target vehicle 20 to be equal to the reference longitudinal distance DLR.

In this embodiment, the reference longitudinal distance may be computed in step E3 based on the corrected longitudinal distance DLCOR and on the driving parameters of the ego vehicle 10 and of the target vehicle 20. Advantageously, the driving parameters include the longitudinal speed of the target vehicle.

FIG. 6 illustrates the sequence of the method and the evolution of the corrected longitudinal distance during a cut-in maneuver of the target vehicle 20 into the lane of the ego vehicle 10, in the case where the relative longitudinal speed VLR of the target vehicle 20 with respect to the ego vehicle 10 is strictly positive. In other words, the target vehicle 20 moves away from the ego vehicle 10 in the course of the cut-in maneuver.

In the example shown, the relative longitudinal speed VLR measured at t=0 s is 10 meters per second.

At t=0 s,
In step E1, a target vehicle 20 having an intention to perform a cut-in maneuver into the lane of the ego vehicle 10 is detected.
The two vehicles are traveling in two separate lanes and the longitudinal distance DLMES₀₁ measured between the target vehicle 20 and the ego vehicle 10 is 5 meters.
In step E2, the time to crossing TLC is estimated. In the example of FIG. 6, the time to crossing TLC is estimated at 1.5 s.
In step E2, a corrected longitudinal distance is computed, DLCOR₀₁=5+10×1.5=20 meters.
In step E3, the corrected longitudinal distance is taken into consideration in order to compute a setpoint longitudinal speed VLC₀₁ for establishing a reference longitudinal distance between the two vehicles. In FIG. 6, it is assumed that the reference longitudinal distance DLR₀₁ computed at the time t=0 s is equal to 25 meters in order to illustrate the effect of the invention. With this implementation of the method, the regulation of the longitudinal speed of the ego vehicle 10 at t=0 will be calibrated based on the difference ΔDLCOR₀₁ between the corrected longitudinal distance DLCOR₀₁ and the reference longitudinal distance DLR₀₁. In other words, the regulation of the longitudinal speed of the ego vehicle 10 will be calibrated in order to change the corrected longitudinal distance DLCOR from 20 meters to 25 meters between the times t=0 and t=TLC=1.5 s, this corresponding to a moderate deceleration. Without implementing the method, at t=0 s, the regulation of the longitudinal speed of the ego vehicle 10 would have been calibrated based on the difference ΔDLMES₀₁ between the measured longitudinal distance DLMES₀₁ and the reference longitudinal distance DLR₀₁. In other words, the regulation of the longitudinal speed of the ego vehicle 10 would have been calibrated so as to change the measured longitudinal distance DLMES from 5 meters to 25 meters between the times t=0 and t=TLC=1.5 s, this corresponding to a strong deceleration.

Thus, in the case where the target vehicle 20 moves away from the ego vehicle 10 during the cut-in maneuver, implementing the method makes it possible to avoid sudden movements linked to the longitudinal regulation with respect to a target at the start of a cut-in maneuver. Implementing the method therefore makes it possible to improve driving comfort.

FIG. 7 illustrates the sequence of the method and the evolution of the corrected longitudinal distance during a cut-in maneuver of the target vehicle 20 into the lane of the ego vehicle 10, in the case where the relative longitudinal speed VLR of the target vehicle 20 with respect to the ego vehicle 10 is strictly negative. In other words, the target vehicle 20 moves toward the ego vehicle 10 during the cut-in maneuver.

In the example shown, the relative longitudinal speed VLR measured at t=0 s is −5 meters per second.

At t=0 s,
In step E1, a target vehicle 20 having an intention to perform a cut-in maneuver into the lane of the ego vehicle 10 is detected.
The two vehicles are traveling in two separate lanes and the longitudinal distance DLMES₀₂ measured between the target vehicle 20 and the ego vehicle 10 is 20 meters.
In step E2, the method estimates the time to crossing TLC. In the example of FIG. 7, said time to crossing TLC is estimated at 1.5 seconds.
In step E2, a corrected longitudinal distance is computed, DLCOR₀₂=20+(−5)×1.5=12.5 meters.
In step E3, the corrected longitudinal distance DLCOR₀₂ is taken into consideration in order to compute a setpoint longitudinal speed VLC for establishing a reference longitudinal distance between the two vehicles. In FIG. 7, it is assumed that the reference longitudinal distance DLR₀₂ computed at the time t=0 s is equal to 25 meters in order to illustrate the effect of the invention. With the implementation of the method, the regulation of the longitudinal speed of the ego vehicle 10 at t=0 will be calibrated based on the difference ΔDLCOR₀₂ between the corrected longitudinal distance DLCOR₀₂ and the reference longitudinal distance DLR₀₂. In other words, the regulation of the longitudinal speed of the ego vehicle 10 will be calibrated so as to change the corrected longitudinal distance DLCOR from 12.5 meters to 25 meters between the times t=0 and t=TLC=1.5 s, this corresponding to a strong deceleration. Without implementing the method, at t=0 s, the regulation of the longitudinal speed of the ego vehicle 10 would have been calibrated based on the difference ΔDLMES₀₂ between the measured longitudinal distance DLMES₀₂ and the reference longitudinal distance DLR₀₂. In other words, the regulation of the longitudinal speed of the ego vehicle 10 would have been calibrated so as to change the measured longitudinal distance DLMES from 20 meters to 25 meters between the times t=0 and t=TLC=1.5 s, this corresponding to an excessively weak deceleration, or even a lack of deceleration to anticipate the approach of the target vehicle. This excessively small deceleration would therefore have to have been followed by a sharp deceleration in order to avoid a collision with the target vehicle.

In the case described by FIG. 7, the cut-in maneuver may be dangerous. The role of the method is here to improve the safety of the vehicle, that is to say to slow the ego vehicle down early and strongly in order to anticipate the approach of the target vehicle.

It is therefore understood that the method may comprise a step of comparing the speed of the ego vehicle and the speed of the second vehicle. The longitudinal speed setpoint computed in the third step E3 is a weak deceleration setpoint if the speed of the second vehicle is strictly greater than the speed of the ego vehicle. The longitudinal speed setpoint is a strong deceleration setpoint if the speed of the second vehicle is strictly less than the speed of the ego vehicle. The amplitude (or absolute value) of the weak acceleration is strictly less than the amplitude of the strong deceleration.

A second mode of execution of a method for the automated management of longitudinal speed is described below with reference to FIG. 4. This second mode of execution of the method comprises four steps E0, E4, E5 and E6.

This mode of execution relates to the implementation of the method for the automated management of longitudinal speed in a context of multi-target longitudinal guidance. In particular, this mode of execution describes the implementation of the method in a traffic configuration shown in FIG. 8.

The traffic configuration shown in FIG. 8 is such that:
the ego vehicle 10, or first vehicle, is positioned in the central lane 40 of a three-lane highway,
a second vehicle 20 is traveling in an adjacent lane 41, 42,
a third vehicle 30 is traveling in the lane of the ego vehicle and ahead thereof,
the second vehicle 20 performs a cut-in maneuver into the central lane, between the ego vehicle and the third vehicle 30.

Step E0 consists of three sub-steps, E1, E2 and E3. The sub-steps E1, E2 and E3 of the second mode of execution are respectively similar to steps E1, E2 and E3 described above for the first mode of execution.

During step E0, the method therefore detects the cut-in maneuver of the second vehicle 20 and computes a first reference longitudinal speed based on a computation of a corrected longitudinal distance between the ego vehicle 10 and the second vehicle 20.

In parallel with the sequence of step E0, in a step E4, the method detects a third vehicle 30.

In a step E5, the method computes a second reference longitudinal speed of the ego vehicle based on the speed of the third vehicle 30.

The first and second reference longitudinal speeds are then processed in a step E6.

In step E6, the method computes the longitudinal speed setpoint for the ego vehicle for maintaining a given minimum longitudinal distance between the ego vehicle 10 and the second and third vehicle 20, 30.

The longitudinal speed setpoint for the ego vehicle will be computed by selecting the minimum longitudinal speed from among the first and second reference longitudinal speeds computed in steps E0 and E5.

The method is thereby in a configuration with guidance with respect to the target having the most constrictive reference longitudinal speed.

1-12. (canceled)

13. A method for automated management of a longitudinal speed of a first vehicle traveling in a first lane, the method comprising:
detecting an intention of a second vehicle traveling in a second lane adjacent to the first lane to perform a cut-in maneuver into the first lane,
estimating a corrected longitudinal distance, said corrected longitudinal distance corresponding to a longitudinal distance that will separate the first vehicle from the second vehicle at the end of the cut-in maneuver, said corrected longitudinal distance being computed based on a longitudinal distance measured between the first vehicle and the second vehicle, and based on a relative longitudinal speed measured between the second vehicle and the first vehicle, and
computing a longitudinal speed setpoint for the first vehicle based on the corrected longitudinal distance.

14. The method for the automated management of the longitudinal speed of the first vehicle as claimed in claim 13, wherein the detecting comprises computing a time to line crossing, and then comparing the time to line crossing with a predefined threshold.

15. The method for the automated management of the longitudinal speed of the first vehicle as claimed in claim 14, wherein said corrected longitudinal distance computed in the estimating depends on the measured longitudinal distance, on the measured relative longitudinal distance and on the time to crossing.

16. The method for the automated management of the longitudinal speed of the first vehicle as claimed in claim 15, wherein said corrected longitudinal distance computed in the estimating is equal to a sum of the measured longitudinal distance and the product of the measured relative longitudinal speed and the time to crossing.

17. The method for the automated management of the longitudinal speed of the first vehicle as claimed in claim 13, wherein the detecting comprises detecting visual indicators on the second vehicle signaling a cut-in maneuver.

18. The method for the automated management of the longitudinal speed of the first vehicle as claimed in claim 17, wherein the visual indicators include detecting use of flashing lights.

19. The method for the automated management of the longitudinal speed of the first vehicle as claimed in claim 13, further comprising comparing the speed of the first vehicle and the speed of the second vehicle, wherein:
the longitudinal speed setpoint computed in said computing is a strong deceleration setpoint when the speed of the second vehicle is strictly less than the speed of the first vehicle, and
the longitudinal speed setpoint computed in said computing is a weak deceleration setpoint when the speed of the second vehicle is strictly greater than the speed of the first vehicle.

20. The method for the automated management of the longitudinal speed of the first vehicle as claimed in claim 13, further comprising:
computing a first reference longitudinal speed based on the corrected longitudinal distance,
detecting at least one third vehicle in traffic around the first vehicle, and
computing at least one second reference longitudinal speed based on a speed of the at least one third vehicle,
wherein the longitudinal speed setpoint computed in the third step is equal to the minimum of the first reference longitudinal speed and the at least one second reference longitudinal speed.

21. The method for the automated management of the longitudinal speed of the first vehicle as claimed in claim 20, wherein the second vehicle and the at least one third vehicle are situated ahead of the first vehicle.

22. A device for the automated management of the longitudinal speed of a vehicle, the device comprising hardware and/or software elements configured to implement the method as claimed in claim 13.

23. A motor vehicle comprising the device for the automated management of the longitudinal speed of a vehicle as claimed in claim 22.

24. A non-transitory computer-readable data recording medium on which is recorded a computer program that, when executed by a computer, causes the computer to execute the method as claimed in claim 13.
